(19) United States
(12) Patent Application Publication
(10) Pub. No.: US 2026/0014991 A1
(43) Pub. Date: Jan. 15, 2026

(54) TRAVEL MODE CONTROLLER AND VEHICLE

(71) Applicant: SUBARU CORPORATION, Tokyo (JP)

(72) Inventors: Keita NAKAHASHI, Tokyo (JP); Koki MATSUMOTO, Tokyo (JP)

(21) Appl. No.: 19/208,683

(22) Filed: May 15, 2025

(30) Foreign Application Priority Data
Jul. 9, 2024 (JP) 2024-110024

(51) Int. Cl. B60W 30/182; B60W 30/18; B60W 40/08

(52) U.S. Cl. CPC B60W 30/182; B60W 30/18072; B60W 40/08; B60W 2040/0827; B60W 2520/105; B60W 2540/106; B60W 2540/14; B60W 2540/229

(57) ABSTRACT

A travel mode controller is configured to control a travel mode of a vehicle including a driving motor, an accelerator pedal, a dummy clutch pedal, and a dummy gear shift lever. The dummy clutch pedal is to be operated by a driver and configured to simulate a clutch operation. The dummy gear shift lever is to be operated by the driver and configured to simulate a shifting operation. The travel mode controller includes one or more processors; and one or more memories communicatably coupled thereto. The travel mode includes a manual transmission mode including validating the shifting operation and the clutch operation. The one or more processors are configured to, in the manual transmission mode, estimate a fatigue state of the driver based on the shifting operation or the clutch operation, and derive a control content of the manual transmission mode based on the estimated fatigue state.

### CROSS-REFERENCE TO RELATED APPLICATIONS

The present application claims priority from Japanese Patent Application No. 2024-110024 filed on Jul. 9, 2024, the entire contents of which are hereby incorporated by reference.

### BACKGROUND

The disclosure relates to a travel mode controller and a vehicle.

There have been known techniques including simulatively reproducing, in a motor-driven electric vehicle, an operation by a driver with respect to a shifting device and a clutch device of a vehicle including a manual transmission that switches a shifting ratio by a manual operation by the driver.

For example, Japanese Unexamined Patent Application Publication (JP-A) No. 2022-030814 describes an electric vehicle that uses an electric motor as a power unit for travel. The electric vehicle includes an acceleration pedal, a dummy clutch pedal, a dummy shifting device, and a controller that controls motor torque to be outputted from the electric motor. The controller includes a memory and a processor. The memory holds an MT vehicle model. The MT vehicle model simulates torque characteristics of driving wheel torque in an MT vehicle including an internal combustion engine and a manual transmission. Torque of the internal combustion engine is controlled by an operation of a gas pedal. A gear stage of the manual transmission is switched by an operation of a clutch pedal and an operation of a shifting device. The processor includes a pedal reaction force imparter. The pedal reaction force imparter performs: accepting an amount of operation of the acceleration pedal as an input of an amount of operation of the gas pedal with respect to the MT vehicle model; accepting an amount of the dummy clutch pedal as an input of an amount of operation of the clutch pedal with respect to the MT vehicle model; accepting a shift position of the dummy shifting device as an input of a shift position of the shifting device in the MT vehicle model; calculating the driving wheel torque using the MT vehicle model; and calculating the motor torque to impart the driving wheel torque to driving wheels of the electric vehicle. The driving wheel torque is determined by the amount of operation of the acceleration pedal, the amount of operation of the dummy clutch pedal, and the shift position of the dummy shifting device. The pedal reaction force imparter generates a pedal reaction force with respect to the operation of the dummy clutch pedal by operation of a reaction force actuator. The controller is configured to control the pedal reaction force to be outputted from the pedal reaction force imparter in accordance with the operation of the dummy clutch pedal.

JP-A No. 2022-044955 describes an electric vehicle that uses an electric motor as a power unit for travel. The electric vehicle includes an acceleration pedal, a dummy clutch pedal, a dummy shifting device, a mode selection switch, and a controller. The mode selection switch allows for selection of a control mode of the electric motor between a first mode and a second mode. The controller controls motor torque to be outputted by the electric motor in accordance with the control mode selected by the mode selection switch. The controller includes a memory and a processor. The memory holds an MT vehicle model and a motor torque command map. The MT vehicle model simulates torque characteristic of driving wheel torque in an MT vehicle including an internal combustion engine and a manual transmission. The internal combustion engine controls torque by an operation of a gas pedal. A gear stage of the manual transmission is switched by an operation of a clutch pedal and an operation of a shifting device. The motor torque command map defines relation of the motor torque with respect to an amount of operation of the acceleration pedal and a rotation speed of the electric motor. The processor is configured to, when controlling the electric motor in the first mode: accept the amount of operation of the acceleration pedal as an input of an amount of operation of the gas pedal with respect to the MT vehicle model; accept an amount of operation of the dummy clutch pedal as an input of an amount of operation of the clutch pedal with respect to the MT vehicle model; accept a shift position of the dummy shifting device as an input of the operation of the shifting device with respect to the MT vehicle model; calculate the driving wheel torque using the MT vehicle model; and calculate the motor torque to impart the driving wheel torque to driving wheels of a subject vehicle. The driving wheel torque is determined by the amount of operation of the acceleration pedal, the amount of operation of the dummy clutch pedal, and the shift position of the dummy shifting device. The processor is configured to, when controlling the electric motor in the second mode: invalidate the operation of the dummy clutch pedal and the operation of the dummy shifting device; and calculate the motor torque using the motor torque command map, based on the amount of operation of the acceleration pedal and the rotation speed of the electric motor. The processor is configured to, in a case where the first mode is selected by the mode selection switch, when any one of the following conditions is established, control the electric motor to produce the motor torque in the second mode. The conditions include that the gear stage of the MT vehicle model is smaller than a predetermined value, and that the vehicle speed of the subject vehicle is smaller than a predetermined value. The gear stage of the MT vehicle model is determined by the shift position.

JP-A No. 2022-030474 describes a control device for an electric vehicle. The control device includes a driving force source including at least a motor, an accelerator pedal to be operated by a driver, and a controller that controls the driving force source. The control device is configured to control a driving force based on an amount of operation of the accelerator pedal. The control device further includes a clutch pedal to be operated by the driver and a travel information acquirer that acquires positional information regarding the electric vehicle and road information regarding a road on which the electric vehicle travels. The controller assumes a virtual engine to serve as the driving force source, and estimates engine torque to be outputted from the virtual engine, and load torque to be applied to the virtual engine, based on the amount of operation of the accelerator pedal and an amount of operation of the clutch pedal. When determining, based on the estimated engine torque and the estimated load torque, that the virtual engine has an engine stall, the controller makes a simulated engine stall control. The simulated engine stall control includes stopping an output of the driving force source and simulatively reproducing an engine stall state. When determining, based on the positional information and the road information acquired by the travel information acquirer, that the electric vehicle is located in a predetermined inhibited place or travels in the inhibited place, the controller inhibits execution of the simulated engine stall control.

### SUMMARY

An aspect of the disclosure provides a travel mode controller configured to control a travel mode of a vehicle. The vehicle includes a driving motor, an accelerator pedal, a dummy clutch pedal, and a dummy gear shift lever. The accelerator pedal is configured to accept an acceleration request from a driver who drives the vehicle. The dummy clutch pedal is configured to be operated by the driver and simulate a clutch operation. The dummy gear shift lever is configured to be operated by the driver and simulate a shifting operation. The travel mode controller includes: one or more processors; and one or more memories communicatably coupled to the one or more processors. The travel mode includes a manual transmission mode including validating the shifting operation and the clutch operation. The one or more processors are configured to, in the manual transmission mode, estimate a fatigue state of the driver based on the shifting operation or the clutch operation, and derive a control content of the manual transmission mode based on the estimated fatigue state.

An aspect of the disclosure provides a vehicle. The vehicle includes a driving motor, an accelerator pedal, a dummy clutch pedal, a dummy gear shift lever, and the travel mode controller. The accelerator pedal is configured to accept an acceleration request from a driver who drives the vehicle. The dummy clutch pedal is configured to be operated by the driver and simulate a clutch operation. The dummy gear shift lever is configured to be operated by the driver and simulate a shifting operation.

An aspect of the disclosure provides a vehicle. The vehicle includes a driving motor, an accelerator pedal, a dummy clutch pedal, a dummy gear shift lever, and a travel mode controller. The accelerator pedal is configured to accept an acceleration request from a driver who drives the vehicle. The dummy clutch pedal is configured to be operated by the driver and simulate a clutch operation. The dummy gear shift lever is configured to be operated by the driver and simulate a shifting operation. The travel mode controller is configured to control a travel mode of the vehicle. The travel mode controller includes one or more processors, and one or more memories communicatably coupled to the one or more processors. The travel mode includes a manual transmission mode including validating the shifting operation and the clutch operation. The one or more processors are configured to, in the manual transmission mode, estimate a fatigue state of the driver based on the shifting operation or the clutch operation, and derive a control content of the manual transmission mode based on the estimated fatigue state.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a schematic diagram of a configuration example of a vehicle including a travel mode controller according to an embodiment of the disclosure.

FIG. 2 is a block diagram of a configuration example of the travel mode controller according to the embodiment of the disclosure.

FIG. 3 illustrates an example of an output transmission ratio of a dummy clutch pedal.

FIG. 4 illustrates another example of the output transmission ratio of the dummy clutch pedal.

FIG. 5 is a flowchart of an operation example of the travel mode controller according to the embodiment of the disclosure.

### DETAILED DESCRIPTION

An MT (Manual Transmission) mode means a driving mode including simulatively reproducing, in an electric vehicle, an operation by a driver in a vehicle including a manual transmission (MT). A vehicle including an MT is hereinafter referred to as an “MT vehicle.” The MT mode gives the driver a feeling of driving as if they are operating an MT vehicle, even when they are driving an electric vehicle. However, in the MT mode, the driver has to make an operation of a dummy clutch in addition to ordinary driving operations in an electric vehicle. This contributes to an increase in a load on the driver, as compared to the case with the ordinary driving operations in an electric vehicle. It is necessary to take some measures to realize safer driving.

The techniques described in JP-A Nos. 2022-030814 and 2022-044955 help the driver to have the feeling of driving as if they are operating a clutch pedal of an MT vehicle, even when they are driving an electric vehicle. The technique described in JP-A No. 2022-030474 helps to inhibit the execution of the simulated engine stall control in the predetermined inhibited place. However, the techniques described in JP-A Nos. 2022-030814, 2022-044955, and 2022-030474 give little consideration to the measures against the load on the driver in the MT mode, and they have still had room for improvement.

It is desirable to provide a travel mode controller and a vehicle that make it possible to reduce a load on a driver and realize safer driving, in an electric vehicle that simulatively reproduces the driver's operation in a vehicle including a manual transmission.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

### <1. Overall Configuration of Vehicle>

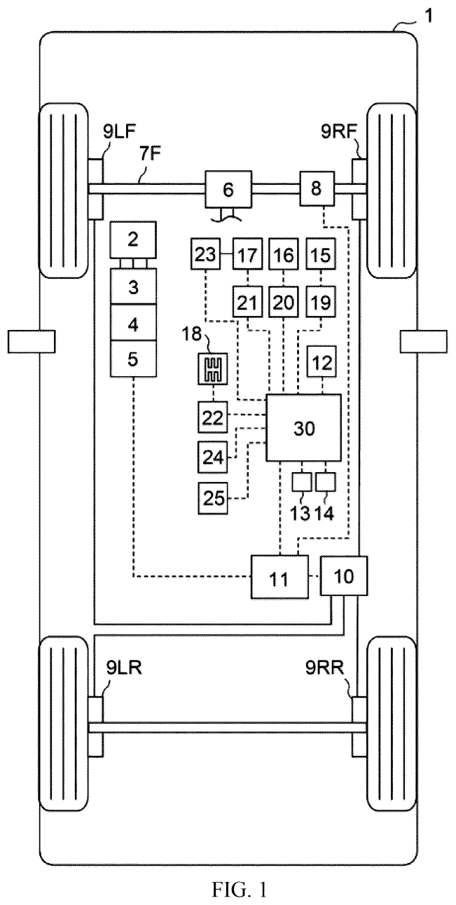

Referring to FIG. 1, description is given of an example of an overall configuration of a vehicle 1 including a travel mode controller 30 according to an embodiment of the disclosure.

The vehicle 1 may include a front-wheel-drive four-wheel vehicle that transmits driving torque outputted from a driving motor 2 to right and left front wheels. Details of the driving motor 2 are described later. There are no particular limitations on the arrangement of the driving wheels and the type of the driving wheels. For example, the vehicle 1 may include a rear-wheel-drive vehicle, a four-wheel-drive vehicle, or a vehicle including a driving motor corresponding to each wheel.

The vehicle 1 includes the driving motor 2, an inverter 3, a converter 4, and a driving battery 5.

The driving motor 2 may output driving torque. The driving torque may be transmitted to the front wheels through a differential mechanism 6 and a front-wheel drive shaft 7F. The driving motor 2 may include a three-phase AC motor. In this case, a three-phase alternating current is supplied to an unillustrated stator to form a rotation magnetic field. By the rotation magnetic field, an unillustrated rotor rotates, and the driving torque is outputted. The driving motor 2 is configured to perform regenerative power generation by the rotation of the rotor receiving rotational torque of the front wheels transmitted through the front-wheel drive shaft 7F, in a state in which the three-phase alternating current is not supplied to the stator. Driving of the driving motor 2 may be controlled by a vehicle controller 11 described later.

The inverter 3 may include an inverter circuit. The inverter circuit may convert DC power swept from the driving battery 5 into three-phase AC power and supply the three-phase AC power to the stator of the driving motor 2. The inverter circuit may convert three-phase AC power produced by the regenerative power generation by the stator of the driving motor 2, into DC power and supply the DC power to the converter 4. Driving of the inverter 3 may be controlled by the vehicle controller 11.

The converter 4 may include a booster circuit. The booster circuit may boost a voltage of electric power produced by the regenerative power generation by the driving motor 2 to a requested charging voltage of the driving battery 5 and supply the resultant voltage to the driving battery 5. The booster circuit may boost or lower an output voltage of the driving battery 5 and supply the resultant voltage to the inverter 3. Driving of the converter 4 may be controlled by the vehicle controller 11.

The driving battery 5 may supply electric power to the driving motor 2. Non-limiting examples of the driving battery 5 may include a rechargeable secondary battery, e.g. a lithium-ion battery or an all-solid battery, having a rated voltage of 200 V to about 800 V. However, the driving battery 5 is not limited to these examples.

The vehicle 1 may further include an electric steering device 8, brake devices 9LF, 9RF, 9LR, and 9RR, and the vehicle controller 11. In the following, the brake devices 9LF, 9RF, 9LR, and 9RR are abbreviated as “brake devices 9” when no particular distinction is necessary.

The electric steering device 8 may be provided on the front-wheel drive shaft 7F. The electric steering device 8 may include an unillustrated electric motor and an unillustrated gear mechanism. The electric steering device 8 may be controlled by the vehicle controller 11 to adjust a steering angle of the front wheels. The vehicle controller 11 may control the electric steering device 8 based on a steering wheel angle of an unillustrated steering wheel to be operated by a driver. When the vehicle 1 is a vehicle configured to make an automated driving control, the vehicle controller 11 is configured to, during manual driving, control the electric steering device 8 based on the steering wheel angle of the steering wheel by the driver. The vehicle controller 11 is configured to, during automated driving, control the electric steering device 8 based on the steering angle or a steering angular velocity set by a known method or any method.

The brake devices 9LF, 9RF, 9LR, and 9RR may impart a braking force to the respective wheels. The brake devices 9 may include, for example, hydraulic brake devices. In this case, hydraulic pressure to be supplied to each of the brake devices 9 may be adjusted by allowing the vehicle controller 11 to control driving of a hydraulic unit 10. The brake devices 9 may be used in combination with a regenerative brake by the driving motor 2.

The vehicle controller 11 may include, for example, one or more electronic control units (ECUs) configured to control the driving of the driving motor 2, the electric steering device 8, and the hydraulic unit 10.

The vehicle 1 may further include an input/output device 12. The input/output device 12 may be driven by the travel mode controller 30, to notify various kinds of information by voice output, text, image display, or the like. The various kinds of information may include, for example, a proposal to the driver, etc. The input/output device 12 may be driven by the travel mode controller 30, to accept the driver's response to the proposal, etc. by voice input or the like. The input/output device 12 may include, for example, a display, a speaker, and a microphone, etc. provided in an instrument panel or the like. The input/output device 12 may include an HUD (Head Up Display) configured to provide display on a windshield glass of the vehicle 1.

The vehicle 1 may further include a vehicle speed sensor 13 and an acceleration rate sensor 14. The vehicle speed sensor 13 may detect a vehicle speed of the vehicle 1. The acceleration rate sensor 14 may detect an acceleration rate of the vehicle 1. Detection signals of the vehicle speed sensor 13 and the acceleration rate sensor 14 may be transmitted to the travel mode controller 30. The vehicle 1 may further include an unillustrated surrounding environment sensor including a front imaging camera, a rear imaging camera, and the like. The vehicle 1 may further include an unillustrated GNSS (Global Navigation Satellite System) sensor. The GNSS sensor may receive satellite signals from positioning satellites such as the GPS (Global Positioning System) satellites.

The vehicle 1 may further include an accelerator pedal 15, a brake pedal 16, a dummy clutch pedal 17, and a dummy gear shift lever 18.

The accelerator pedal 15 is configured to accept an acceleration request from the driver. On the accelerator pedal 15, an accelerator pedal sensor 19 may be provided. The accelerator pedal sensor 19 may detect an amount of stepping down of the accelerator pedal 15 by the driver. Detection signals of the accelerator pedal sensor 19 may be transmitted to the travel mode controller 30.

The brake pedal 16 may accept a braking request from the driver. On the brake pedal 16, a brake pedal sensor 20 may be provided. The brake pedal sensor 20 may detect an amount of stepping down of the brake pedal 16 by the driver. Detection signals of the brake pedal sensor 20 may be transmitted to the travel mode controller 30.

The dummy clutch pedal 17 and the dummy gear shift lever 18 may accept a dummy shifting request from the driver. However, the vehicle 1 includes an electric vehicle to be driven by the driving motor 2, and lacks an internal combustion engine such as a gasoline engine or a diesel engine as a driving force source. Thus, the vehicle 1 lacks a clutch mechanism and a transmission mechanism included in an ordinary MT vehicle.

The dummy clutch pedal 17 is to be operated by the driver and configured to simulate a clutch operation. That is, the dummy clutch pedal 17 has a structure that simulates a clutch pedal included in an ordinary MT vehicle. The arrangement of the dummy clutch pedal 17 is equivalent to an ordinary MT vehicle. The dummy clutch pedal 17 is stepped down when, for example, the dummy gear shift lever 18 is operated by the driver. On the dummy clutch pedal 17, a dummy clutch pedal sensor 21 may be provided. The dummy clutch pedal sensor 21 may detect an amount of stepping down of the dummy clutch pedal 17 by the driver. Moreover, to the dummy clutch pedal 17, a reaction force actuator 23 may be coupled. The reaction force actuator 23 is to be driven by the travel mode controller 30 and is configured to generate a pedal reaction force that acts in a direction in which a stepping-down force of the dummy clutch pedal 17 by the driver is cancelled. Although details are described later, magnitude of the pedal reaction force may be also controlled by the travel mode controller 30. There are no particular limitations on the structure of the reaction force actuator 23. The reaction force actuator 23 may have a known structure. Detection signals of the dummy clutch pedal sensor 21 may be transmitted to the travel mode controller 30.

The dummy gear shift lever 18 is to be operated by the driver and configured to simulate a shifting operation. That is, the dummy gear shift lever 18 has a structure that simulates a gear shift lever such as a so-called H pattern included in an ordinary MT vehicle. The arrangement of the dummy gear shift lever 18 and the feeling of operation of the dummy gear shift lever 18 are equivalent to an ordinary MT vehicle. The dummy gear shift lever 18 is to be manually operated by the driver when the driver inputs a dummy shifting request to the vehicle 1. On the dummy gear shift lever 18, a dummy gear shift lever sensor 22 may be provided. The dummy gear shift lever sensor 22 may detect a shift position of the dummy gear shift lever 18. Detection signals of the dummy gear shift lever sensor 22 may be transmitted to the travel mode controller 30.

The vehicle 1 may further include a shift switch 24 in addition to the dummy gear shift lever 18 to be operated by the driver during an MT mode. The shift switch 24 is to be operated by the driver during an AT mode. A shift position of the shift switch 24 may include P (parking), R (reverse), N (neutral), D (drive), and the like. The shift switch 24 is preferable from the viewpoint of facilitating a blind operation by the driver, but a normal gear shift lever may be employed instead of the shift switch 24. Moreover, from a similar viewpoint, during the AT mode, the dummy gear shift lever 18 may be retracted inside the vehicle under the control of an ECU or the like. Furthermore, during the MT mode, under the control of an ECU or the like, the shift switch 24 may be retracted inside the vehicle, or alternatively, a position lamp may be turned off. The position lamp is configured to indicate the shift position of the shift switch 24.

In addition, the vehicle 1 may further include a vehicle body vibration generator 25. The vehicle body vibration generator 25 is to be driven by the travel mode controller 30, and is configured to generate vehicle body vibration simulating an ordinary MT vehicle when the dummy clutch pedal 17 or the dummy gear shift lever 18 is operated by the driver. This makes it possible to bring the feeling of operation of the dummy clutch pedal 17 or the dummy gear shift lever 18 close to the feeling of operation of an ordinary MT vehicle. The vehicle body vibration generator 25 may be attached to, for example, an unillustrated suspension provided in the vehicle 1. There are no particular limitations on a structure of the vehicle body vibration generator 25. For example, the vehicle body vibration generator 25 may include an electric cylinder, a hydraulic cylinder, or a gas cylinder.

### <2. Travel Mode Controller>

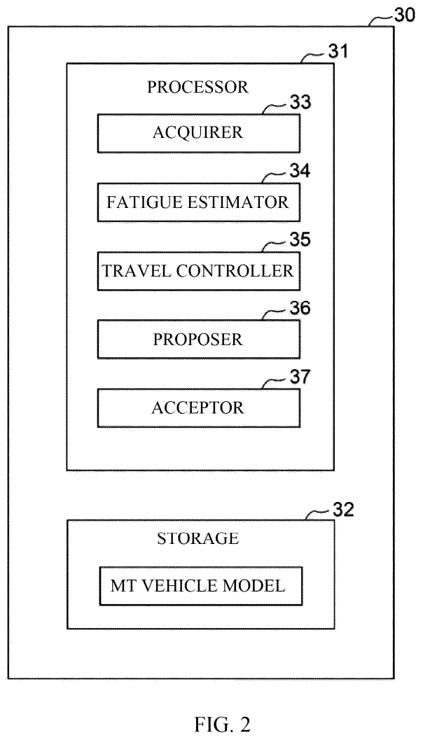

The travel mode controller 30 according to the embodiment is described with reference to FIG. 2.

### <2-1. Configuration Example>

The travel mode controller 30 is configured to control travel modes of the vehicle 1 by a processor such as one or more CPUs (Central Processing Units) executing a computer program. The computer program is a computer program that causes the processor to perform operation described later to be performed by the travel mode controller 30. The computer program to be executed by the processor may be held in a recording medium that serves as a storage 32, or a memory, described later. Instead, the computer program may be held in a recording medium built in the travel mode controller 30 or any recording medium externally attachable to the travel mode controller 30.

The recording medium that holds the computer program may be a magnetic medium such as a hard disk, a floppy disk, and a magnetic tape, an optical recording medium such as a CD-ROM, a DVD, and a Blu-ray (registered trademark), a magneto-optical medium such as a floptical disk, a storage element such as a RAM and a ROM, a flash memory such as a USB memory and an SSD, or any other medium configured to hold programs.

To the travel mode controller 30, the vehicle controller 11, the input/output device 12, the vehicle speed sensor 13, and the acceleration rate sensor 14 may be coupled through a communicator such as a dedicated line, or a CAN (Controller Area Network) or a LIN (Local Inter Net). Moreover, to the travel mode controller 30, the accelerator pedal 15 and the accelerator pedal sensor 19, the brake pedal 16 and the brake pedal sensor 20, the dummy clutch pedal 17, the dummy clutch pedal sensor 21 and the reaction force actuator 23, the dummy gear shift lever 18 and the dummy gear shift lever sensor 22, the shift switch 24, and the vehicle body vibration generator 25 may be coupled through the communicator such as the dedicated line, or the CAN or the LIN. It is to be noted that a part or all of the configuration of the travel mode controller 30 may be provided in the vehicle controller 11.

The travel mode controller 30 may include a processor 31 and the storage 32.

### <Processor>

The processor 31 may include one or more processors such as a CPU, and various peripheral components. A part or all of the processor 31 may include that which is updatable such as firmware, or may include a program module or the like to be executed by a command from a CPU or the like.

### <Storage>

The storage 32 may include one or more storage elements such as a RAM or a ROM communicatably coupled to the processor 31. There are no particular limitations on the kind of the storage 32, and the number of the storages 32. The storage 32 may hold computer programs to be executed by the processor 31, various parameters to be used in calculation processing, data such as detection data and calculation results. In the storage 32, an MT vehicle model may be held in advance. The MT vehicle model simulates an ordinary MT vehicle described later.

### <2-2. Configuration of Processor>

A configuration of the processor 31 of the travel mode controller 30 is described. The processor 31 may include an acquirer 33, a fatigue estimator 34, a travel controller 35, a proposer 36, and an acceptor 37. The acquirer 33, the fatigue estimator 34, the travel controller 35, the proposer 36, and the acceptor 37 may be realized by the one or more processors such as the CPU executing the computer programs. However, some or all of the acquirer 33, the fatigue estimator 34, the travel controller 35, the proposer 36, and the acceptor 37 may include an analog circuit.

### <Acquirer>

The acquirer 33 is configured to acquire the amount of stepping down of the accelerator pedal 15 by the driver based on the detection signal from the accelerator pedal sensor 19, and store the amount of stepping down of the accelerator pedal 15 in the storage 32. The acquirer 33 is also configured to acquire the amount of stepping down of the brake pedal 16 by the driver based on the detection signal from the brake pedal sensor 20, and store the amount of stepping down of the brake pedal 16 in the storage 32. The acquirer 33 is also configured to acquire the amount of stepping down of the dummy clutch pedal 17 by the driver based on the detection signal from the dummy clutch pedal sensor 21, and store the amount of stepping down of the dummy clutch pedal 17 in the storage 32. The acquirer 33 is also configured to acquire the shift position of the dummy gear shift lever 18 based on the detection signal from the dummy gear shift lever sensor 22, and store the shift position in the storage 32.

### <Fatigue Estimator>

The fatigue estimator 34 is configured to estimate a fatigue state of the driver based on the shifting operation or the clutch operation by the driver. In one example, the fatigue estimator 34 may estimate the fatigue state of the driver as a first fatigue state, when a parameter value based on the amount of stepping down of the accelerator pedal 15, the amount of stepping down of the dummy clutch pedal 17, or the operation of the dummy gear shift lever 18 satisfies a first condition. The fatigue estimator 34 may estimate the fatigue state of the driver as a second fatigue state, when the parameter value based on the amount of stepping down of the accelerator pedal 15, the amount of stepping down of the dummy clutch pedal 17, or the operation of the dummy gear shift lever 18 satisfies a second condition. The first condition means a condition for the estimation of the fatigue state of the driver as the first fatigue state. The second condition means a condition for the estimation of the fatigue state of the driver as the second fatigue state in which the driver is more fatigued than the first fatigue state. Accordingly, the first condition and the second condition are different conditions.

The first condition may include one or more of the following conditions:
that the number of times a dummy engine stall occurs is equal to or larger than a threshold value A1;
that the number of times erroneous shifting of the dummy gear shift lever 18 occurs is equal to or larger than a threshold value B1;
the number of times insufficient stepping down of the dummy clutch pedal 17 occurs is equal to or larger than a threshold value C1; and
the number of times abrupt acceleration occurs in which the acceleration rate of the vehicle 1 is higher than a reference acceleration rate is equal to or larger than a threshold value D1.

The acceleration rate of the vehicle 1 is acquirable from the acceleration rate sensor 14. The reference acceleration rate may be set in advance in consideration of a legal speed or the like, or alternatively, the reference acceleration rate may be dynamically set in accordance with a vehicle speed range to which the vehicle speed of the vehicle 1 acquired from the vehicle speed sensor 13 belongs. The threshold values A1, B1, C1, and D1 may be appropriately set in accordance with the kinds of the parameters and stored in the storage 32 in advance.

The second condition may include one or more of the following conditions:
that the number of times the dummy engine stall occurs is equal to or larger than a threshold value A2;
that the number of times the erroneous shifting of the dummy gear shift lever 18 occurs is equal to or larger than a threshold value B2; and
that the number of times the insufficient stepping down of the dummy clutch pedal 17 occurs is equal to or larger than a threshold value C2.

The threshold values A2, B2, and C2 may be appropriately set in accordance with the kinds of the parameters and stored in the storage 32 in advance.

The threshold value A2 may be set to a larger value than the threshold value A1. The threshold value B2 may be set to a larger value than the threshold value B1. The threshold value C2 may be set to a larger value than the threshold value C1. As described later in detail, a determination regarding the second condition may be made when the first condition is satisfied. When the first condition is satisfied, an output transmission ratio to the driving motor 2 may be set to a smaller value than a reference transmission ratio. Accordingly, even if the dummy clutch pedal 17 is roughly operated by the driver, the vehicle 1 does not accelerate abruptly. Thus, unlike the first condition, the second condition does not have to include the condition related to the abrupt acceleration.

The fatigue estimator 34 may estimate an occurrence of the dummy engine stall, when an engine stall is simulatively reproduced by the travel controller 35 based on the amount of stepping down of the dummy clutch pedal 17, the shift position of the dummy gear shift lever 18, and the like. The fatigue estimator 34 may estimate an occurrence of the erroneous shifting, when the shift position detected by the dummy gear shift lever sensor 22 is an inappropriate position. The inappropriate shift position means a shift position to be determined by the travel controller 35 in accordance with the vehicle speed and the like of the vehicle 1, and that is different from an appropriate shift position at which no dummy engine stall or the like occurs. The fatigue estimator 34 may estimate an occurrence of the insufficient stepping down of the dummy clutch pedal 17, when the amount of stepping down of the dummy clutch pedal 17 is smaller than a reference amount of stepping down. The fatigue estimator 34 may estimate an occurrence of the abrupt acceleration, when a rate of change in the amount of stepping down of the accelerator pedal 15 is larger than a reference rate of change.

### <Travel Controller: AT Mode>

The travel controller 35 may make the following controls in the AT mode out of the travel modes. The AT mode includes invalidating the shifting operation and the clutch operation by the driver. It is to be noted that the switching of the travel modes may be made by the controls by the travel controller 35 described later, or by an operation by the driver of an unillustrated changeover switch provided in the vehicle 1.

The travel controller 35 may derive the driving torque decided by the amount of stepping down of the accelerator pedal 15 by the driver. The travel controller 35 may derive motor torque to be imparted to driving wheels of the vehicle 1, from the derived driving torque. The travel controller 35 may transmit a control signal based on the derived motor torque to the inverter 3 through the vehicle controller 11. The inverter 3 may control the driving torque of the driving motor 2 based on the control signal received from the vehicle controller 11.

### <Travel Controller: MT Mode>

The travel controller 35 may make the following controls in the MT mode out of the travel modes. The MT mode includes validating the shifting operation and the clutch operation by the driver.

The travel controller 35 may accept the amount of stepping down of the accelerator pedal 15 by the driver, as an amount of stepping down of an accelerator pedal that controls fuel supply to an internal combustion engine in an ordinary MT vehicle. The travel controller 35 may accept the amount of stepping down of the dummy clutch pedal 17 by the driver, as an amount of stepping down of a clutch pedal that brings a clutch into operation in an ordinary MT vehicle. The travel controller 35 may accept the operation of the dummy gear shift lever 18 by the driver, as an operation of a gear shift lever that switches a gear stage in an ordinary MT vehicle. The travel controller 35 may derive, using the MT vehicle model simulating an ordinary MT vehicle, the driving torque to be decided by the amount of stepping down of the accelerator pedal 15, the amount of stepping down of the dummy clutch pedal 17, and the shift position of the dummy gear shift lever 18. The MT vehicle model may be a known model disclosed in JP-A No. 2024-043344 or the like. The MT vehicle model may be stored in advance in the storage 32 as described above. The travel controller 35 may derive, from the derived driving torque, the motor torque to be imparted to the driving wheels of the vehicle 1. The travel controller 35 may transmit the control signal based on the derived motor torque to the inverter 3 through the vehicle controller 11. The inverter 3 may control the driving torque of the driving motor 2 based on the control signal received from the vehicle controller 11.

This helps the driver to get, when changing the shift position or when starting the vehicle 1, the feeling of changing the gear stage by the operation of the dummy gear shift lever 18, adjusting the vehicle speed by the operation of the accelerator pedal 15, and the like in a similar manner to an ordinary MT vehicle, in addition to the operation of the dummy clutch pedal 17. The travel controller 35 may also reproduce, when detecting an inappropriate operation of the dummy clutch pedal 17 or the dummy gear shift lever 18 by the driver, the dummy engine stall by making a control to stop the output of the driving motor 2 based on the MT vehicle model.

In this way, the travel controller 35 may derive control contents of the MT mode. The control contents of the MT mode may include, for example:
deciding the output of the driving motor 2 in accordance with the amount of stepping down of the accelerator pedal 15;
deciding the output transmission ratio to the driving motor 2 in accordance with the amount of stepping down of the dummy clutch pedal 17;
changing output characteristics of the driving motor 2 in accordance with the shift position of the dummy gear shift lever 18; and
deciding the pedal reaction force of the dummy clutch pedal 17.

The output transmission ratio and the pedal reaction force may be appropriately set to initial values in accordance with taste of the driver, and may be stored in advance in the storage 32. In the embodiment, the travel controller 35 may impose the following limitations on the control contents of the MT mode described above, based on the fatigue state of the driver estimated by the fatigue estimator 34.

In one example, the travel controller 35 may derive, when the fatigue estimator 34 estimates the fatigue state of the driver as the first fatigue state, the control contents that include setting the output transmission ratio to the driving motor 2 decided in accordance with the amount of stepping down of the dummy clutch pedal 17 to a smaller value than the reference transmission ratio, as the control contents of the MT mode.

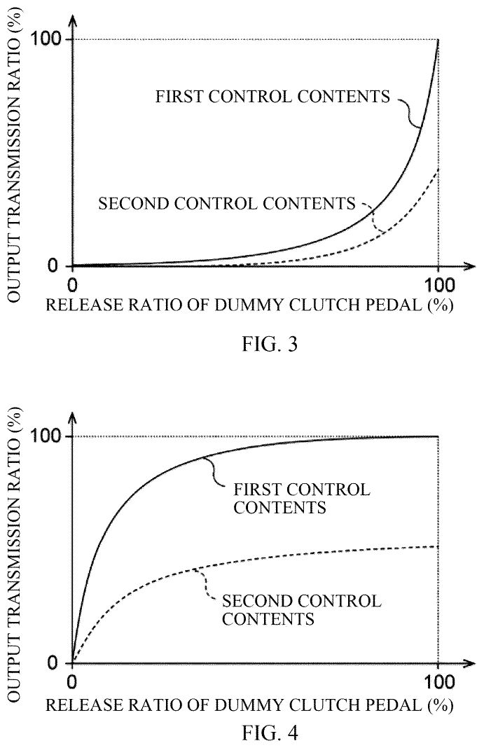

Referring to FIG. 3, a case is described in which the vehicle 1 is a vehicle in which a dummy engine of the MT vehicle model is disconnected from a dummy transmission mechanism when the amount of stepping down of the dummy clutch pedal 17 is 100%. The output transmission ratio with respect to a release ratio of the dummy clutch pedal 17 may have a characteristic indicated by a solid line in a normal state, whereas in the first fatigue state, the output transmission ratio may have a characteristic indicated by a broken line shifted down from the solid line over the entirety of the release ratio.

Referring to FIG. 4, in a case where the vehicle 1 is a vehicle in which the dummy engine of the MT vehicle model is disconnected from the dummy transmission mechanism when the amount of stepping down of the dummy clutch pedal 17 is 0%, the output transmission ratio with respect to the release ratio of the dummy clutch pedal 17 has a characteristic indicated by a solid line in a normal state, whereas in the first fatigue state, the output transmission ratio may have a characteristic indicated by a broken line shifted down from the solid line over the entirety of the release ratio.

Additionally or alternatively, the travel controller 35 may derive, when the fatigue estimator 34 estimates the fatigue state of the driver as the first fatigue state, the control contents that include setting the pedal reaction force of the dummy clutch pedal 17 to a smaller value than a reference reaction force, as the control content of the MT mode.

Additionally or alternatively, the travel controller 35 may derive, when the fatigue estimator 34 estimates the fatigue state of the driver as the first fatigue state, the control contents that include causing the vehicle 1 to coast when an erroneous operation of the dummy gear shift lever 18 by the driver is detected, as the control content of MT mode. Here, “to coast” means making the vehicle 1 creep. Thus, even if an erroneous operation of the dummy gear shift lever 18 by the driver occurs, it is possible to suppress an impact on the vehicle body caused by a regenerative brake or behavior just before the dummy engine stall. Non-limiting examples of the “erroneous operation” may include, but are not limited to, a change in the shift position from the fifth speed to the second speed, a change in the shift position from the second speed to the fifth speed, and the like.

Moreover, the travel controller 35 may make, when the fatigue estimator 34 estimates the fatigue state of the driver as the second fatigue state different from the first fatigue state, a control to switch from the MT mode to the AT mode.

### <Proposer>

Back to FIG. 2, the proposer 36 may control driving of the input/output device 12 to perform processing to make a proposal of, for example, a result of derivation by the travel controller 35 to the driver. The proposal may be made by audio output, image display, or text display.

### <Acceptor>

The acceptor 37 may control the driving of the input/output device 12 to perform processing to accept a response of the driver to the proposal by the proposer 36. The response may be made by voice input or the like.

### <2-3. Operation Example of Travel Mode Controller>

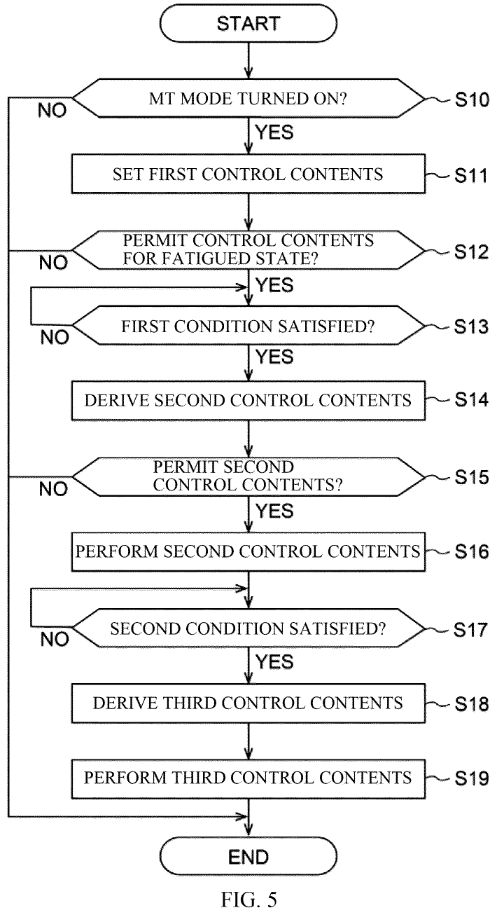

Referring to a flowchart in FIG. 5, an operation example of the travel mode controller 30 according to the embodiment is described.

In step S10, the travel controller 35 may determine whether the MT mode is turned ON. When it is determined that the MT mode is turned ON (step S10: YES), the processing may proceed to step S11. When it is determined that the MT mode is not turned ON (step S10: NO), the processing may end.

In step S11, the travel controller 35 may set first control contents, as the control contents of the MT mode. In this operation example, the first control contents may include setting the output transmission ratio to the driving motor 2 and the pedal reaction force of the dummy clutch pedal 17 to the initial values set in advance in accordance with the taste of the driver. This helps the driver to feel as if they are driving in a similar manner to an ordinary MT vehicle, with the output transmission ratio and the pedal reaction force that suit their taste. Thereafter, the processing may proceed to step S12.

In step S12, the proposer 36 may perform processing to make a proposal to the driver as to whether to derive the control contents corresponding to the fatigue state of the driver, as the control contents of the MT mode. When there is a response from the driver regarding permission of the control contents corresponding to the fatigue state (step S12: YES), the processing may proceed to step S13. When there is a response from the driver regarding inhibition of the control contents corresponding to the fatigue state (step S12: NO), the processing may end.

It is to be noted that, instead of step S12, for example, when a so-called sport mode is in operation, the processing may end. In the sport mode, the output characteristic of the driving motor 2 becomes steeper than normal, e.g., an upper limit of the acceleration rate of the vehicle 1 is set to a higher value than normal.

In step S13, the fatigue estimator 34 may determine whether the parameter value based on the amount of stepping down of the accelerator pedal 15, the amount of stepping down of the dummy clutch pedal 17, or the operation of the dummy gear shift lever 18 satisfies the first condition for the estimation of the fatigue state of the driver as the first fatigue state.

In this operation example, the first condition may include: a condition (i) that the number of times the dummy engine stall occurs is equal to or larger than the threshold value A1; a condition (ii) that the number of times the erroneous shifting of the dummy gear shift lever 18 occurs is equal to or larger than the threshold value B1; a condition (iii) that the number of times the insufficient stepping down of the dummy clutch pedal 17 occurs is equal to or larger than the threshold value C1; and a condition (iv) that the number of times the abrupt acceleration of the vehicle 1 occurs is equal to or larger than the threshold value D1. The fatigue estimator 34 may make the determinations regarding the conditions (i) to (iv) in parallel, or alternatively, the fatigue estimator 34 may sequentially make the determinations in any order. The fatigue estimator 34 may initialize the number of times in each of the conditions (i) to (iv) to “zero (0)” prior to the process in step S13. In one embodiment of the disclosure, the first condition does not have to include all the conditions (i) to (iv). It suffices that the first condition includes one or more of the conditions (i) to (iv).

When it is determined that the first condition is satisfied (step S13: YES), the fatigue estimator 34 may estimate the fatigue state of the driver as the first fatigue state, and the processing may proceed to step S14. When it is determined that the first condition is not satisfied (step S13: NO), the processing may return to step S13.

In step S14, the travel controller 35 may derive second control contents, as the control contents of the MT mode. In this operation example, the second control contents may include setting the output transmission ratio to the driving motor 2 decided in accordance with the amount of stepping down of the dummy clutch pedal 17 to a smaller value than the reference transmission ratio. The second control contents may further include setting the pedal reaction force of the dummy clutch pedal 17 to a smaller value than the reference reaction force. The second control contents may further include causing the vehicle 1 to coast when an erroneous operation of the dummy gear shift lever 18 by the driver is detected. However, the second control contents do not have to include all the three control contents described above. It suffices that the second control contents include one or more of these control contents. Thereafter, the processing may proceed to step S15.

In one example, in step S14, the travel controller 35 may limit the control to set the output transmission ratio to a smaller value than the reference transmission ratio, to predetermined time from the time of a start of the operation of the dummy clutch pedal 17 by the driver, and after an elapse of the predetermined time, make a control to restore the output transmission ratio to the reference transmission ratio. One reason for this is because the output transmission ratio kept smaller than the reference transmission ratio is not sufficient to provide a necessary output when the vehicle travels on an expressway, an uphill, or the like. In one example, the travel controller 35 may make a control to gradually restore the output transmission ratio to the reference transmission ratio as time passes from the start of the operation of the dummy clutch pedal 17, by calculating the output transmission ratio by Expression 1 as follows.

Output transmission ratio (%)=setting value (%)+{100(%)−setting value (%)}×elapsed time/predetermined time Expression 1

In Expression 1, the “setting value” means the output transmission ratio at the start of the operation of the dummy clutch pedal 17, and is set to a smaller value than the reference transmission ratio. In Expression 1, the “elapsed time” means elapsed time from the start of the operation of the dummy clutch pedal 17. In Expression 1, the “predetermined time” is, for example, several seconds to about several tens of seconds. However, the embodiment of the disclosure is not limited thereto, but the “predetermined time” may be appropriately set.

In step S15, the proposer 36 may perform processing to make the proposal to the driver as to whether to permit the control in accordance with the second control contents derived in step S14. When there is a response from the driver regarding the permission of the control in accordance with the second control contents (step S15: YES), the processing may proceed to step S16. When there is a response from the driver regarding the inhibition of the control in accordance with the second control contents (step S15: NO), the processing may end. The proposal helps the driver to notice that they are tired. This step is optional and may be omitted.

In step S16, the travel controller 35 may make the control in accordance with the second control contents. In one example, the travel controller 35 may derive the motor torque by the method described above in accordance with the second control contents, and transmit the control signal based on the derived motor torque to the inverter 3. Thus, the inverter 3 may control the driving torque of the driving motor 2 based on the control signal received from the travel controller 35. Thereafter, the processing may proceed to step S17.

In step S17, the fatigue estimator 34 may determine whether the parameter value based on the amount of stepping down of the accelerator pedal 15, the amount of stepping down of the dummy clutch pedal 17, or the operation of the dummy gear shift lever 18 satisfies the second condition for the estimation of the fatigue state of the driver as the second fatigue state in which the driver is more fatigued than the first fatigue state.

In this operation example, the second condition may include: a condition (v) that the number of times the dummy engine stall occurs is equal to or larger than the threshold value A2; a condition (vi) that the number of times the erroneous shifting of the dummy gear shift lever 18 occurs is equal to or larger than the threshold value B2; and a condition (vii) that the number of times the insufficient stepping down of the dummy clutch pedal 17 occurs is equal to or larger than the threshold value C2. The fatigue estimator 34 may make the determinations regarding the conditions (v) to (vii) in parallel, or alternatively, the fatigue estimator 34 may sequentially make the determinations in any order. The fatigue estimator 34 may initialize the number of times in each of the conditions (v) to (vii) to “zero (0)” prior to the process in step S17. In one embodiment of the disclosure, the second condition does not have to include all the conditions (v) to (vii). It suffices that the second condition includes one or more of the conditions (v) to (vii).

When it is determined that the second condition is satisfied (step S17: YES), the fatigue estimator 34 may estimate the fatigue state of the driver as the second fatigue state in which the driver is more fatigued than the first fatigue state, and the processing may proceed to step S18. When it is determined that the second condition is not satisfied (step S17: NO), the processing may return to step S17.

In step S18, the travel controller 35 may derive third control contents as the control contents of the MT mode. In this operation example, the third control contents may include switching from the MT mode to the AT mode. That is, because the driver is in the second fatigue state in which the driver has more accumulated fatigue than the first fatigue state, the MT mode may be compulsively turned OFF from the viewpoint of safety. Thereafter, the processing may proceed to step S19.

In step S19, the travel controller 35 may make the control in accordance with the third control contents. In one example, the travel controller 35 may invalidate the shifting operation and the clutch operation by the driver in accordance with the third control contents, derive the motor torque by the control method described above in the AT mode, and transmit the control signal based on the derived motor torque to the inverter 3. Thus, the inverter 3 may control the driving torque of the driving motor 2 based on the control signal received from the travel controller 35. Thereafter, the processing may end.

Within the various kinds of the processing included in this operation example, the processing after step S13 may be performed at timing at which predetermined time has elapsed since the driver starts driving. The predetermined time may be set as appropriate in consideration of, for example, accumulation of fatigue caused by driving.

### <Effects>

As described above, the travel mode controller 30 according to the embodiment is configured to control the travel modes of the vehicle 1. The vehicle 1 includes the driving motor 2, the accelerator pedal 15, the dummy clutch pedal 17, and the dummy gear shift lever 18. The accelerator pedal 15 is configured to accept the acceleration request from the driver. The dummy clutch pedal 17 is to be operated by the driver and configured to simulate the clutch operation. The dummy gear shift lever 18 is to be operated by the driver and configured to simulate the shifting operation. The travel modes include the MT mode including validating the shifting operation and the clutch operation. The processor 31 of the travel mode controller 30 is configured to, in the MT mode, estimate the fatigue state of the driver based on the shifting operation or the clutch operation, and derive the control contents of the MT mode based on the estimated fatigue state.

With such a configuration, it is possible to control the travel modes of the vehicle 1 in accordance with the fatigue state of the driver of the vehicle 1. In particular, it is possible to detect, based on the operation of the dummy clutch pedal 17 or the like, a potential fatigue state that is difficult to detect by a known driver monitoring system, e.g., accumulation of physical fatigue with clear consciousness without sleepiness or the like. Hence, in an electric vehicle that simulatively reproduces the operation of the driver in an MT vehicle, it is possible to reduce a burden on the driver and realize safer driving.

In one modification example, in steps S13 and S17, the fatigue estimator 34 may estimate the fatigue state of the driver based on comparison between the number of times the dummy engine stall occurs in a first period since the driver starts driving, and the number of times the dummy engine stall occurs in a second period after an elapse of the first period since the driver starts driving. In one example, the fatigue estimator 34 may estimate the fatigue state of the driver as the first fatigue state, when the number of times the dummy engine stall occurs in the second period is larger than the number of times the dummy engine stall occurs in the first period by a preset first difference. The fatigue estimator 34 may estimate the fatigue state of the driver as the second fatigue state, when the number of times the dummy engine stall occurs in the second period is larger than the number of times the dummy engine stall occurs in the first period by a preset second difference. The second difference is a value larger than the first difference. This helps to distinguish between the occurrence of the dummy engine stall caused by the driver's lack of skill and the occurrence of the dummy engine stall caused by the fatigue of the driver. The first period and the second period may be appropriately set in consideration of, for example, the driver's fatigue caused by driving.

Although some example embodiments of the disclosure have been described in the foregoing by way of example with reference to the accompanying drawings, the disclosure is by no means limited to the embodiments described above. It should be appreciated that modifications and alterations may be made by persons skilled in the art without departing from the scope as defined by the appended claims. The disclosure is intended to include such modifications and alterations in so far as they fall within the scope of the appended claims or the equivalents thereof.

For example, the constituent elements or the processing in each step may be rearranged without logical inconsistencies. Some of the constituent elements or some steps may be combined together or divided up.

The technology of the disclosure is applicable not only to the vehicle 1 described above but also a vehicle including a known electrically-controllable transmission or a vehicle including any electrically-controllable transmission.

The technology of the disclosure may be realized by the vehicle 1 including the travel mode controller 30 described in the forgoing embodiment, a travel mode control method to be performed by the travel mode controller 30, a computer program that causes a computer to serve as the travel mode controller 30 described above, and a non-transitory tangible recording medium containing the computer program.

The travel mode controller 30 illustrated in FIG. 1 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the travel mode controller 30. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the travel mode controller 30 illustrated in FIG. 1.

1. A travel mode controller configured to control a travel mode of a vehicle, the vehicle comprising a driving motor, an accelerator pedal, a dummy clutch pedal, and a dummy gear shift lever, the accelerator pedal being configured to accept an acceleration request from a driver who drives the vehicle, the dummy clutch pedal being configured to be operated by the driver and simulate a clutch operation, and the dummy gear shift lever being configured to be operated by the driver and simulate a shifting operation,
the travel mode controller comprising:
one or more processors; and
one or more memories communicatably coupled to the one or more processors,
the travel mode comprising a manual transmission mode including validating the shifting operation and the clutch operation, and
the one or more processors being configured to,
in the manual transmission mode,
estimate a fatigue state of the driver based on the shifting operation or the clutch operation, and
derive a control content of the manual transmission mode based on the estimated fatigue state.

2. The travel mode controller according to claim 1, wherein
the one or more processors are configured to,
in the manual transmission mode,
when a parameter value satisfies a first condition for estimation of the fatigue state as a first fatigue state, the parameter value being based on an amount of stepping down of the accelerator pedal, an amount of stepping down of the dummy clutch pedal, or an operation of the dummy gear shift lever,
derive, as the control content, one or more of:
setting an output transmission ratio to the driving motor to a smaller value than a reference transmission ratio, the output transmission ratio being decided in accordance with the amount of stepping down of the dummy clutch pedal;
setting a pedal reaction force of the dummy clutch pedal to a smaller value than a reference reaction force; and
allowing the vehicle to coast when an erroneous operation of the dummy gear shift lever by the driver is detected.

3. The travel mode controller according to claim 2, wherein
the travel mode further comprises an automatic transmission mode including invalidating the shifting operation and the clutch operation, and
the one or more processors are configured to,
in the manual transmission mode,
when the parameter value satisfies a second condition for the estimation of the fatigue state as a second fatigue state in which the driver is more fatigued than the first fatigue state,
make a switching control from the manual transmission mode to the automatic transmission mode.

4. The travel mode controller according to claim 2, wherein
the parameter value comprises one or more of:
how many times a dummy engine stall occurs;
how many times erroneous shifting of the dummy gear shift lever occurs;
how many times insufficient stepping down of the dummy clutch pedal occurs; and
how many times abrupt acceleration occurs in which an acceleration rate of the vehicle is higher than a reference acceleration rate.

5. The travel mode controller according to claim 3, wherein
the parameter value comprises one or more of:
how many times a dummy engine stall occurs;
how many times erroneous shifting of the dummy gear shift lever occurs;
how many times insufficient stepping down of the dummy clutch pedal occurs; and
how many times abrupt acceleration occurs in which an acceleration rate of the vehicle is higher than a reference acceleration rate.

6. A vehicle comprising:
a driving motor;
an accelerator pedal configured to accept an acceleration request from a driver;
a dummy clutch pedal configured to be operated by the driver and simulate a clutch operation;
a dummy gear shift lever configured to be operated by the driver and simulate a shifting operation; and
the travel mode controller according to claim 1.

7. A vehicle comprising:
a driving motor;
an accelerator pedal configured to accept an acceleration request from a driver;
a dummy clutch pedal configured to be operated by the driver and simulate a clutch operation;
a dummy gear shift lever configured to be operated by the driver and simulate a shifting operation; and
a travel mode controller configured to control a travel mode of the vehicle,
the travel mode controller comprising
one or more processors, and
one or more memories communicatably coupled to the one or more processors,
the travel mode comprising a manual transmission mode including validating the shifting operation and the clutch operation,
the one or more processors being configured to,
in the manual transmission mode,
estimate a fatigue state of the driver based on the shifting operation or the clutch operation, and
derive a control content of the manual transmission mode based on the estimated fatigue state.
